(19) United States
(12) Patent Application Publication
(10) Pub. No.: US 2014/0068040 A1
(43) Pub. Date: Mar. 6, 2014

(54) System for Enabling Server Maintenance Using Snapshots

(71) Applicants: Kodanda Rama Krishna Neti, Hyderabad (IN); Amit Vishwas, Secunderabad (IN)

(72) Inventors: Kodanda Rama Krishna Neti, Hyderabad (IN); Amit Vishwas, Secunderabad (IN)

(73) Assignee: Bank of America Corporation, Charlotte, NC (US)

(21) Appl. No.: 13/602,822

(22) Filed: Sep. 4, 2012

(51) Int. Cl. G06F 15/16

(52) U.S. Cl. 709/223

(57) ABSTRACT

In certain embodiments, a system includes a target server operable to access one or more databases. The target is further operable to run one or more processes supporting access to the one or more databases. The system also includes a management server including one or more processors. The management server is operable to receive a maintenance request. The maintenance request includes a maintenance window. The management server is further operable to generate a server state snapshot by capturing the identities and configurations of the one or more processes running on the target server. The management server is further operable to stop the one or more processes. The management server is further operable to restore, after the expiration of the maintenance window, the one or more processes based on the server state snapshot.

### TECHNICAL FIELD OF THE INVENTION

The present disclosure relates generally to server maintenance and more specifically to a system for enabling server maintenance using snapshots.

### BACKGROUND OF THE INVENTION

A server may host and/or support a number of applications, services, websites, and/or databases. If server maintenance is necessary, these applications, services, websites and/or databases may need to be shut down, stopped, and/or taken off-line during the maintenance and then restored following the maintenance. However, systems supporting server maintenance have proven inadequate in various respects.

### SUMMARY OF THE INVENTION

In certain embodiments, a system includes a target server operable to access one or more databases. The target is further operable to run one or more processes supporting access to the one or more databases. The system also includes a management server including one or more processors. The management server is operable to receive a maintenance request. The maintenance request includes a maintenance window. The management server is further operable to generate a server state snapshot by capturing the identities and configurations of the one or more processes running on the target server. The management server is further operable to stop the one or more processes. The management server is further operable to restore, after the expiration of the maintenance window, the one or more processes based on the server state snapshot.

In other embodiments, a method includes receiving a maintenance request. The maintenance request includes an identity of a target server. The method also includes generating, by one or more processors, a server state snapshot by capturing information about one or more processes running on the target server. The method also includes stopping, by the one or more processors, the one or more processes. The method also includes restoring, by the one or more processors, the one or more processes based on the server state snapshot.

In further embodiments, one or more non-transitory computer-readable storage media embody logic. The logic is operable when executed to receive a maintenance request. The maintenance request includes an identity of a target server. The logic is further operable when executed to generate a server state snapshot by capturing information about one or more processes running on the target server. The logic is further operable when executed to stop the one or more processes. The logic is further operable when executed to restore the one or more processes based on the server state snapshot.

Particular embodiments of the present disclosure may provide some, none, or all of the following technical advantages. Certain embodiments may allow a user to create a maintenance window on a server without the user having any knowledge about processes and/or services running on the server or their configurations. Because a server can swiftly be restored to its pre-maintenance state after maintenance is completed, certain embodiments may reduce server downtime for any given maintenance operation, resulting in better load balancing across the network. Thus, certain embodiments may conserve computing resources and network bandwidth by preventing the other servers on the network from being overloaded due to server maintenance outages. By restoring the server based on a captured server snapshot, rather than relying on a pre-existing configuration file which may or may not be accurate, certain embodiments may provide increased reliability that the pre-maintenance state is properly restored. By allowing a maintenance request to specify multiple servers and/or multiple maintenance windows for each server, certain embodiments may increase efficiency and provide a scalable means of maintaining large numbers of servers at the same time. Avoiding the need for separate requests for the multiple servers and/or multiple maintenance windows may also conserve computational resources and network bandwidth. Certain embodiments may also increase efficiency and reduce the need for human labor, correspondingly eliminating the possibility of human errors being introduced into the system. By verifying that a server has been fully restored to its pre-maintenance state and notifying a user of any problems, certain embodiments may conserve computational resources and avoid server downtime that would otherwise result from having the server running in an unrestored and possibly non-operational state.

### BRIEF DESCRIPTION OF THE DRAWINGS

For a more complete understanding of the present disclosure and its advantages, reference is made to the following descriptions, taken in conjunction with the accompanying drawings in which:

FIG. 1 illustrates an example system for enabling server maintenance using snapshots, according to certain embodiments of the present disclosure;

FIG. 2 illustrates an example method for enabling server maintenance using snapshots, according to certain embodiments of the present disclosure;

FIG. 3 illustrates an example method for capturing a snapshot of a server, according to certain embodiments of the present disclosure;

FIG. 4 illustrates an example method for stopping processes and/or services on a server, according to certain embodiments of the present disclosure; and

FIG. 5 illustrates an example method for starting and/or configuring processes and/or services on a server, according to certain embodiments of the present disclosure.

### DETAILED DESCRIPTION OF THE INVENTION

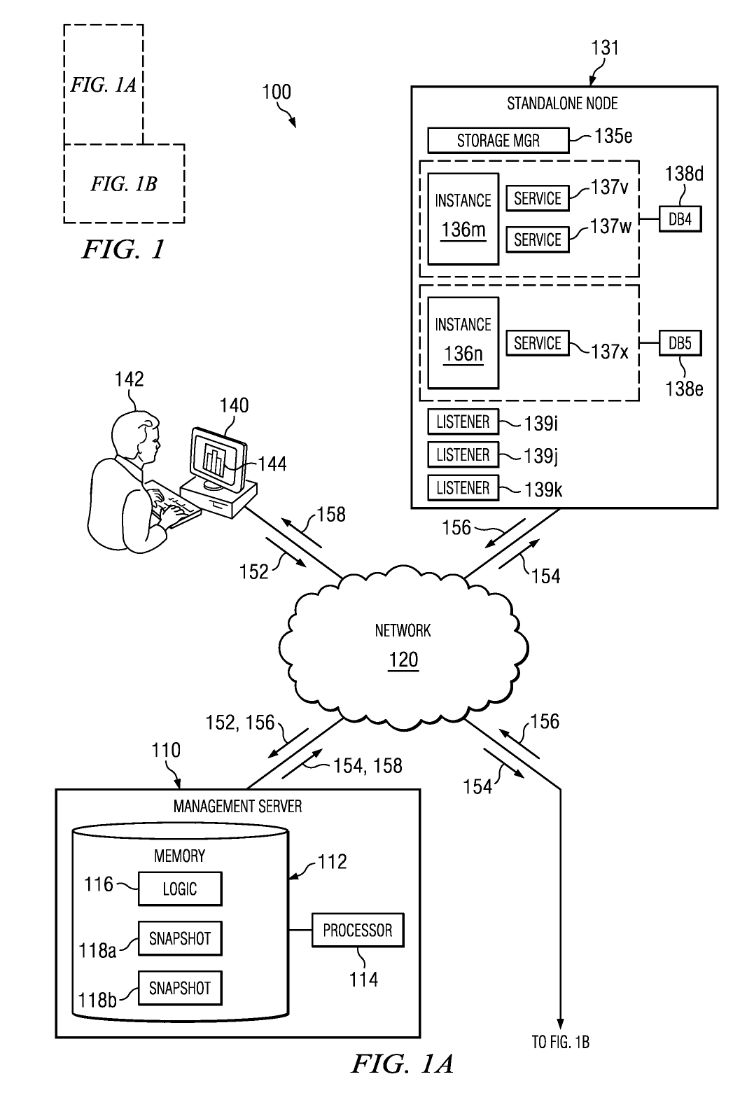

Embodiments of the present disclosure and their advantages are best understood by referring to FIGS. 1 through 5 of the drawings, like numerals being used for like and corresponding parts of the various drawings.

FIG. 1 illustrates an example system 100 for enabling server maintenance using snapshots, according to certain embodiments of the present disclosure. In general, the system may provide a maintenance window for one or more target servers by stopping some or all of the services, processes, applications, and/or databases running on the server. The maintenance window may be a period of time during which necessary maintenance can be performed on the server, such as updating software running on the server. At the end of the maintenance window, the system may restore each target server to its pre-maintenance state, for example by restarting some or all of the services, processes, applications, and/or databases that were stopped to create the maintenance window. In particular, system 100 may include one or more management servers 110, one or more target servers (such as standalone node 131 and/or clustered nodes 132a-d within clustered environment 130), one or more clients 140, and one or more users 142. Management server 110, standalone node 131, clustered environment 130, clustered nodes 132a-d, and client 140 may be communicatively coupled by a network 120. Management server 110 is generally operable to provide a maintenance window for one or more of standalone node 131 and clustered nodes 132a-d, as described below.

In certain embodiments, network 120 may refer to any interconnecting system capable of transmitting audio, video, signals, data, messages, or any combination of the preceding. Network 120 may include all or a portion of a public switched telephone network (PSTN), a public or private data network, a local area network

(LAN), a metropolitan area network (MAN), a wide area network (WAN), a local, regional, or global communication or computer network such as the Internet, a wireline or wireless network, an enterprise intranet, or any other suitable communication link, including combinations thereof.

Client 140 may refer to any device that enables user 142 to interact with management server 110, standalone node 131, clustered nodes 132a-d, and/or clustered environment 130. In some embodiments, client 140 may include a computer, workstation, telephone, Internet browser, electronic notebook, Personal Digital Assistant (PDA), pager, smart phone, tablet, laptop, or any other suitable device (wireless, wireline, or otherwise), component, or element capable of receiving, processing, storing, and/or communicating information with other components of system 100. Client 140 may also comprise any suitable user interface such as a display, microphone, keyboard, or any other appropriate terminal equipment usable by a user 142. It will be understood that system 100 may comprise any number and combination of clients 140. Client 140 may be utilized by user 142 to interact with management server 110 in order to diagnose and correct a problem with target servers 130a-b, as described below.

In some embodiments, client 140 may include a graphical user interface (GUI) 144. GUI 144 is generally operable to tailor and filter data presented to user 142. GUI 144 may provide user 142 with an efficient and user-friendly presentation of information. GUI 144 may additionally provide user 142 with an efficient and user-friendly way of inputting and submitting maintenance requests 152 to management server 110. GUI 144 may comprise a plurality of displays having interactive fields, pull-down lists, and buttons operated by user 142. GUI 144 may include multiple levels of abstraction including groupings and boundaries. It should be understood that the term graphical user interface 144 may be used in the singular or in the plural to describe one or more graphical user interfaces 144 and each of the displays of a particular graphical user interface 144.

In some embodiments, standalone node 131 may include, for example, a mainframe, server, host computer, workstation, web server, file server, a personal computer such as a laptop, or any other suitable device operable to process data. In some embodiments, standalone node 131 may execute any suitable operating system such as IBM's zSeries/Operating System (z/OS), MS-DOS, PC-DOS, MAC-OS, WINDOWS, Linux, UNIX, OpenVMS, or any other appropriate operating systems, including future operating systems. In some embodiments, standalone node 131 may be a web server. For example, standalone node 131 may be running Microsoft's Internet Information Server™. System 100 may include any suitable number of standalone nodes 131. In certain embodiments, each standalone node 131 may represent a server. In certain other embodiments, multiple standalone nodes 131 may run on a single server.

In some embodiments, standalone node 131 may host, access, and/or provide access to one or more databases 138d-e. In other embodiments, standalone node 131 may additionally or alternatively host, access, and/or provide access to one or more applications, services, processes, and/or websites. A database 138 may represent an organized and/or structured collection of data in any suitable format. Databases 138d-e may be stored internally or externally to standalone node 131. One or more instances 136m-n may be running on standalone node 131 and may access databases 138d-e. In some embodiments, each instance 136 may access a different database 138. In the example of FIG. 1, instance 136m accesses database 138d, and instance 136n accesses database 138e. Each instance 136 may have one or more associated services 137. Services 137 may support the associated instance 136 and/or may provide some of all of the functionality of the associated instance 136. Each service 137 may have an associated state. For example, the state of a service 137 may indicate whether the service 137 is currently enabled or disabled (i.e. running or stopped). In the example of FIG. 1, instance 136m has two associated services 137v-w, and instance 136n has one associated service 137x. An instance 136 may have any suitable number of associated services 137, according to particular needs.

One or more listeners 139i-k may be running on standalone node 131. A listener 139 may be a process or service that receives requests to access databases 138 and/or instances 136 (e.g. from client 140 and/or user 142). In response to a request concerning a particular database 138 (e.g. database 138e), a listener 139 may connect to the appropriate instance 136 (e.g. instance 136n) to fetch data from the particular database 138. Alternatively, the listener 139 may facilitate a direct connection between the source of the request and the appropriate instance 136.

Storage manager 135e may manage storage for standalone node 131. For example, storage manager 135e may provide a volume manager and/or a file system manager for databases 138d-e and/or files associated with databases 138d-e. In some embodiments, storage manager 135e may allow a plurality of physical storage devices to be accessed and/or addressed as a single logical device or disk group. Although particular numbers of storage managers 135, instances 136, services 137, databases 138, and listeners 139 have been illustrated and described, this disclosure contemplates any suitable number and combination of storage managers 135, instances 136, services 137, databases 138, and listeners 139, according to particular needs.

In some embodiments, clustered environment 130 may include one or more clustered nodes 132. In some embodiments, clustered nodes 132a-d may include, for example, a mainframe, server, host computer, workstation, web server, file server, a personal computer such as a laptop, or any other suitable device operable to process data. In some embodiments, clustered nodes 132a-d may execute any suitable operating system such as IBM's zSeries/Operating System (z/OS), MS-DOS, PC-DOS, MAC-OS, WINDOWS, Linux, UNIX, OpenVMS, or any other appropriate operating systems, including future operating systems. In some embodiments, clustered nodes 132a-d may be web servers. For example, clustered nodes 132a-d may be running Microsoft's Internet Information Server™. In certain embodiments, each clustered node 132 may represent a server. In certain other embodiments, multiple clustered nodes 132 may run on a single server. System 100 may include any suitable number of clustered environments 130 and any other suitable number of clustered nodes 132.

In some embodiments, each clustered node 132 may host, access, and/or provide access to one or more databases 138a-c. In other embodiments, a clustered node 132 may additionally or alternatively host, access, and/or provide access to one or more applications, services, processes, and/or websites. A database 138 may represent an organized and/or structured collection of data in any suitable format. Databases 138a-c may be stored internally or externally to any given clustered node 132 and/or clustered environment 130. One or more instances 136 may be running on a clustered node 132 and may access databases 138a-c. In some embodiments, each instance 136 running on a given clustered node 132 may access a different database 138. In some embodiments, multiple instances, each running on a different clustered node 132, may access a single database 138. In the example of FIG. 1, instance 136a running on clustered node 132a, instance 136d running on clustered node 132b, instance 136g running on clustered node 132c, and instance 136j running on clustered node 132d may all access database 138a. Likewise, instance 136b running on clustered node 132a, instance 136e running on clustered node 132b, instance 136h running on clustered node 132c, and instance 136k running on clustered node 132d may all access database 138b. Further, instance 136c running on clustered node 132a, instance 136f running on clustered node 132b, instance 136i running on clustered node 132c, and instance 136l running on clustered node 132d may all access database 138c.

Each instance 136 may have one or more associated services 137. Services 137 may support the associated instance 136 and/or may provide some or all of the functionality of the associated instance 136. Each service 137 may have an associated state. For example, the state of a service 137 may indicate whether the service 137 is currently enabled or disabled (i.e. running or stopped). Instances 136 running on a single clustered node 132 may have differing numbers and/or combinations of services 137 associated with them. Likewise, instances 136 running on different clustered nodes 132 and accessing a common database 138 may have differing numbers and/or combinations of services 137. In the example of FIG. 1, instance 136a has three associated services 137a-c, instance 136b has two associated services 137d-e, and instance 136c has three associated services 137f-h. Some instances 136 may have no associated services 137 (e.g. instance 136h running on clustered node 132c). An instance 136 may have any suitable number of associated services 137, according to particular needs.

One or more listeners 139a-h may be running on a clustered node 132. A listener 139 may be a process or service that receives requests to access databases 138 and/or instances 136 (e.g. from client 140 and/or user 142). In response to a request concerning a particular database 138 (e.g. database 138c), a listener 139 may connect to the appropriate instance 136 (e.g. instance 136c in the case of listeners 139a-b running on clustered node 132a) to fetch data from the particular database 138. Alternatively, the listener 139 may facilitate a direct connection between the source of the request and the appropriate instance 136.

A storage manager 135 running on a clustered node 132 may manage storage for the clustered node 132. For example, storage managers 135a-d may provide a volume manager and/or a file system manager for databases 138a-c and/or files associated with databases 138a-c. In some embodiments, storage managers 135e may allow a plurality of physical storage devices to be accessed and/or addressed as a single logical device or disk group.

A virtual IP interface 133 of a clustered node 132 may represent or provide a communication interface to the clustered node 132 that uses a virtual IP (Internet Protocol) address. In certain embodiments, all of the virtual IP interfaces 133a-d may share the same virtual IP subnet to provide redundancy; in the case of a failure of a clustered node 132, another clustered node 132 may receive and respond to a request directed to the shared virtual IP address.

A cluster service 134 running on a clustered node 132 may facilitate communication between the clustered node 132 and other clustered nodes 132 within the clustered environment 130. Cluster services 134a-d may collectively coordinate the operations of the clustered nodes 132 within the clustered environment 130 and may provide functions such as inter-node message routing and clustered node failure detection. In some embodiments, cluster services 134a-d may manage and/or control the virtual IP address associated with virtual IP interfaces 133a-d.

Although particular numbers of virtual IP interfaces 133, cluster services 134, storage managers 135, instances 136, services 137, databases 138, and listeners 139 have been illustrated and described, this disclosure contemplates any suitable number and configuration of virtual IP interfaces 133, cluster services 134, storage managers 135, instances 136, services 137, databases 138, and listeners 139, according to particular needs.

In some embodiments, management server 110 may refer to any suitable combination of hardware and/or software implemented in one or more modules to process data and provide the described functions and operations. In some embodiments, the functions and operations described herein may be performed by a pool of management servers 110. In some embodiments, management server 110 may include, for example, a mainframe, server, host computer, workstation, web server, file server, a personal computer such as a laptop, or any other suitable device operable to process data. In some embodiments, management server 110 may execute any suitable operating system such as IBM's zSeries/Operating System (z/OS), MS-DOS, PC-DOS, MAC-OS, WINDOWS, Linux, UNIX, OpenVMS, or any other appropriate operating systems, including future operating systems. In some embodiments, management server 110 may be a web server. For example, management server 110 may be running Microsoft's Internet Information Server™.

In general, management server 110 provides maintenance windows for one or more of standalone node 131 and clustered nodes 132a-d for users 142. In some embodiments, management server 110 may include a processor 114 and server memory 112. Server memory 112 may refer to any suitable device capable of storing and facilitating retrieval of data and/or instructions. Examples of server memory 112 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile computer-readable memory devices that store one or more files, lists, tables, or other arrangements of information. Although FIG. 1 illustrates server memory 112 as internal to management server 110, it should be understood that server memory 112 may be internal or external to management server 110, depending on particular implementations. Also, server memory 112 may be separate from or integral to other memory devices to achieve any suitable arrangement of memory devices for use in system 100.

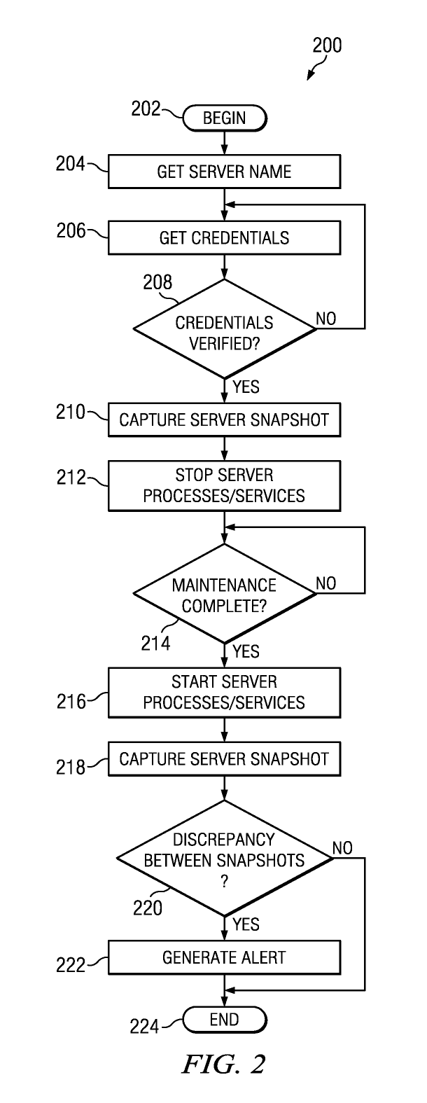

Server memory 112 is generally operable to store logic 116 and snapshots 118a-b. Logic 116 generally refers to logic, rules, algorithms, code, tables, and/or other suitable instructions for performing the described functions and operations. Snapshots 118a-b may be any collection of information concerning a target server (e.g. standalone node 131 and/or clustered nodes 132a-d). For example, snapshots 118a-b may identify one or more services, processes, applications, and/or databases running on one or more target servers or any other suitable information. Snapshots 118a-b may also contain state information, parameters, settings, configuration data and/or any other suitable information concerning the target server and/or some or all of those services, processes, application, and/or databases. In general, management server 110 may utilize one or more snapshots 118 to provide a maintenance window for a target server. Example methods for capturing a snapshot 118 for a target server are described in more detail below in connection with FIG. 3.

Server memory 112 may be communicatively coupled to processor 114. Processor 114 may be generally operable to execute logic 116 stored in server memory 112 to provide a maintenance window for a target server according to this disclosure. Processor 114 may include one or more microprocessors, controllers, or any other suitable computing devices or resources. Processor 114 may work, either alone or with components of system 100, to provide a portion or all of the functionality of system 100 described herein. In some embodiments, processor 114 may include, for example, any type of central processing unit (CPU).

In operation, logic 116, when executed by processor 114, enables maintenance of standalone node 131 and/or clustered nodes 132a-d for users 142. To perform these functions, logic 116 may first receive a maintenance request 152, for example from a user 142 via client 140. A maintenance request 152 may include information identifying a target server, such as a server name, IP address, and/or other suitable information. A user 142 may send a maintenance request 152 indicating that a particular standalone node 131 or clustered node 132 needs to undergo maintenance. For example, a user 142 may send a maintenance request 152 identifying a particular node when the node needs to have its hardware or software components updated, when the node and/or the server hosting the node needs to be restarted or rebooted, when a new security patch or bug fix needs to be applied, or for any other suitable reason. In some embodiments, the target server may be one or more of standalone node 131 and/or clustered nodes 132a-d. In other embodiments, the target server may be a server running or hosting one or more of standalone node 131 and/or clustered nodes 132a-d.

In some embodiments, upon receiving the request, logic 116 may perform operations to provide a maintenance window. A maintenance window may represent a period of time during which some or all of the services, processes, applications, and/or databases that were running on the server are stopped or terminated. The maintenance window may have a predetermined duration. Alternatively, the duration of the maintenance window may be specified in maintenance request 152.

In alternative embodiments, maintenance may be scheduled in advance, instructing logic 116 to perform the operations necessary to provide a maintenance window at a future time. The start time and stop time for the maintenance window may be included in maintenance request 152. Alternatively, the maintenance request 152 may include a start time and a duration for the maintenance window. Alternatively, the maintenance request 152 may include a start time, and logic 116 may use a predetermined duration for the maintenance window.

In some embodiments, maintenance request 152 may include or be accompanied by user credentials. User credentials may represent any username, password, permissions, access code, or other information used to gain access to the target server (e.g. standalone node 131 and/or clustered nodes 132a-d) and/or management server 110. Before providing a maintenance window for the target server, management server 110 may verify the credentials provided to ensure that the requestor has the necessary permission to initiate a maintenance window.

Logic 116 may be operable to generate snapshots 118a-b of a target server. As described above, snapshots 118a-b may be any collection of information concerning a target server (e.g. standalone node 131 and/or clustered nodes 132a-d). For example, snapshots 118a-b may identify one or more services, processes, applications, and/or databases running on one or more target servers or any other suitable information. Snapshots 118a-b may also contain state information, parameters, settings, configuration data and/or any other suitable information concerning the target server and/or some or all of those services, processes, application, and/or databases. An example method for capturing snapshots 118a-b of a target server is described in more detail in connection with FIG. 3.

Logic 116 may capture the information used to generate snapshots 118a-b by sending one or more commands 154 to a target server, and receiving in response data 156. In some embodiments, commands 154 may represent a script to be executed on a target server. In capturing snapshots 118a-b, logic 116 may request and receive information regarding the identity, state and/or configuration of one or more of virtual IP interfaces 133, cluster services 134, storage managers 135, instances 136, services 137, databases 138, and listeners 139, among other things. For each instance 136, logic 116 may determine the identities and states of any services 137 associated with that instance 136, including, for example, whether a service 137 is enabled or disabled. For each instance 136, logic 116 may also determine a software version associated with the instance 136, its associated services 137, and/or the databases 138 it accesses. Logic 116 may also determine state information for each instance 136. State information may include whether the instance 136 represents a primary instance of a database or a standby instance of a database. State information may also include whether the instance 136 is operating in a read-only, read-write, or mount mode. A mount mode may indicate that instance 136 is running and has access to a database 138, but is inaccessible to a user wishing to access the database 138.

A standby instance 136 may have an associated recovery process and a corresponding primary instance 136. A recovery process may allow a standby instance 136 to receive updates about changes made to the corresponding primary instance 136 so that data remains in sync between the primary instance 136 and the corresponding standby instance 136. Thus, if a problem or failure occurs with the primary instance 136, the standby instance 136 can act as a backup or can be used to recover any data lost. Logic 116 may be operable to capture recovery process information (such as configuration information and/or the identity of the corresponding primary instance 136) for any instance 136 in a standby state.

Logic 116 may also be operable to capture information about any monitoring processes/agents or enterprise managers running on a target server. A monitoring process/agent may monitor the state of other processes and/or services running on the target server, and may generate an alert or a log file entry if any of those processes and/or services terminate or experience a problem. An enterprise manager may manage some or all of the operations of a standalone node 131, clustered node 132, or a target server running one or more standalone nodes 131 and/or clustered nodes 132. The enterprise manager may also provide reporting information regarding instances 136, services 137, and/or databases 138, such as used or available disk space for a database 138, or the identities of users logged in to and/or accessing an instance 136, service 137, and/or database 138. Logic 116 may be operable to determine whether a monitoring process/agent or enterprise manager is running on a target server, and to capture configuration information for each.

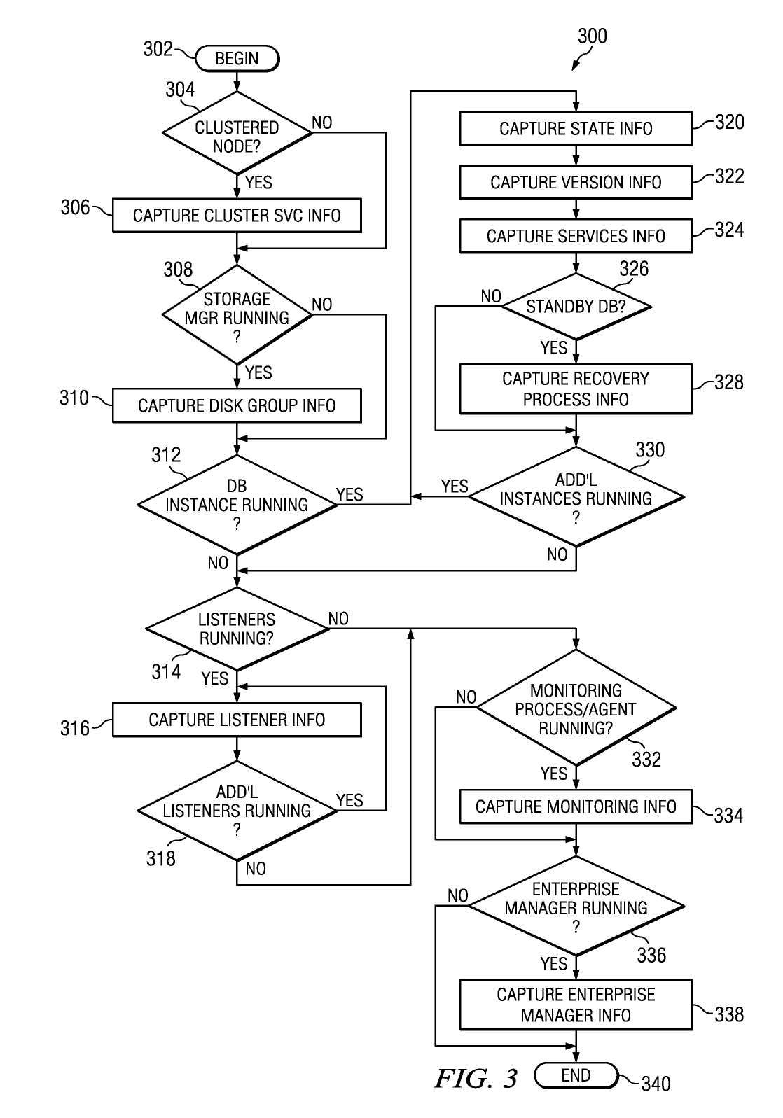

Once logic 116 has created a pre-maintenance snapshot 118 (e.g. snapshot 118a) of a target server, logic 116 may stop or terminate one or more of the applications, processes and/or services running on the target server. Logic 116 may accomplish this by sending one or more commands 154 to the target server. Logic 116 may be operable to terminate a monitoring process/agent, an enterprise manager, cluster services 134, storage managers 135, instances 136, listeners 139, and/or any other suitable applications, processes, and/or services. In some embodiments, logic 116 may notify user 142 and/or any other appropriate person or system that the requested maintenance window has begun. In some embodiments, it may be desirable to stop or terminate the applications, processes, and/or services in a particular order. An example method for stopping processes and/or services on a target server will be described in more detail in connection with FIG. 4.

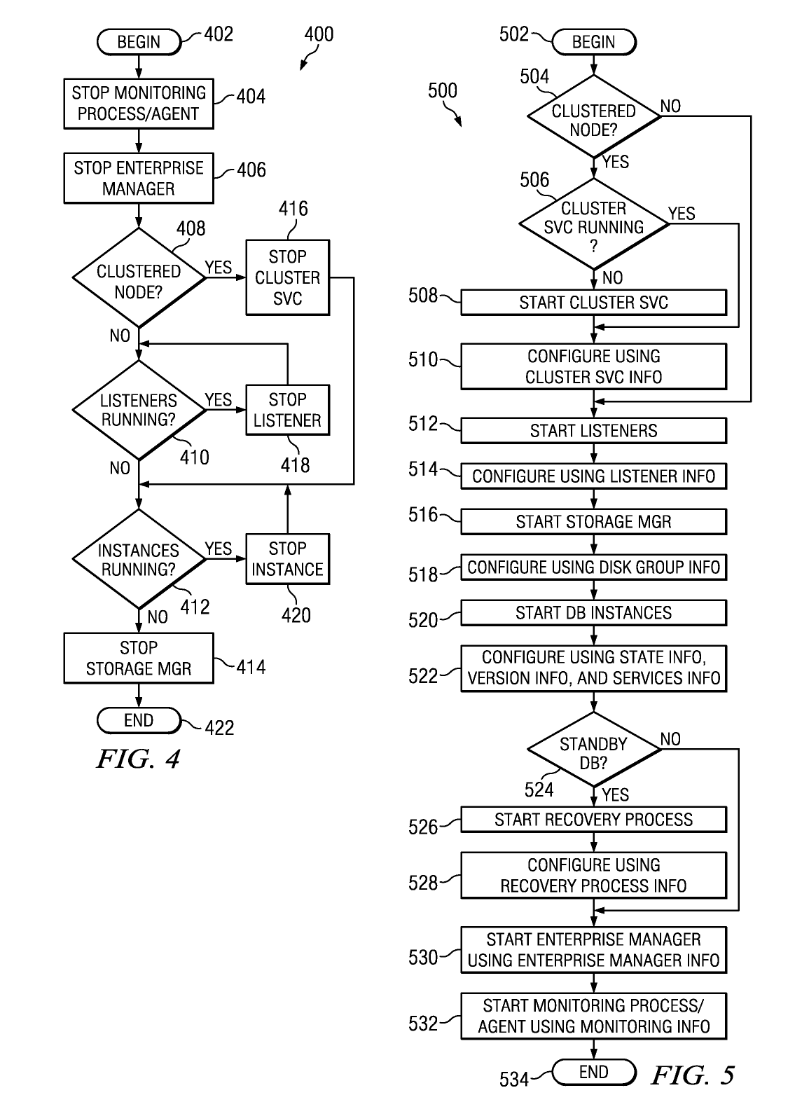

After the expiration of the maintenance window, logic 116 may be operable to restore the target server to its pre-maintenance state based on the captured snapshot 118. Logic may start and/or configure processes and/or services on the target server, based on the information contained in the captured snapshot 118, by sending one or more commands 154 to the target server. Logic 116 may be operable to start and/or configure a monitoring process/agent, an enterprise manager, cluster services 134, storage managers 135, instances 136, services 137, listeners 139, a recovery process, and/or any other suitable applications, processes, and/or services. In some embodiments, it may be desirable to start and/or configure the applications, processes, and/or services in a particular order. In some embodiments, logic 116 may notify user 142 and/or any other appropriate person or system that the requested maintenance window has ended. An example method for starting and/or configuring processes and/or services on a target server will be described in more detail in connection with FIG. 5.

Logic 116 may be operable to verify that the target server has been properly restored to its pre-maintenance state. Logic 116 may be operable to generate a second snapshot 118 (i.e. a post-maintenance snapshot, e.g. 118b) of the target server. The post-maintenance snapshot 118b may be captured in the same manner as the pre-maintenance snapshot 118a, described above. Logic 116 may be operable to compare pre-maintenance snapshot 118a with post-maintenance snapshot 118b and identify any discrepancies. A discrepancy may indicate that the pre-maintenance server state has not been fully restored. For example, one or more of the service and/or processes may have failed to start. As another example, one or more of the services and/or processes may not be running with the desired configuration. In some embodiments, logic 116 may attempt to correct the problem. For example, if one or more of the services and/or processes failed to start, logic 116 may attempt to start those services and/or processes again. In the case of a configuration problem, logic 116 may attempt to configure the affected processes and/or services in order to cure the identified discrepancies.

If discrepancies between the two snapshots 118 are identified (and/or cannot be corrected by logic 116), logic 116 may generate an alert 158. The alert may be written to a log file, communicated to a system administrator (e.g. via e-mail, text message, etc.), or may take any other suitable format. In some embodiments, alert 158 may be transmitted to user 142 via client 140 and displayed on GUI 144. The alert may include the identified discrepancies, any actions taken to attempt to correct the discrepancies, and/or any other suitable information. In some embodiments, an alert 158 may be generated even when there are no identified discrepancies in order to inform user 142 that the target server state was successfully restored.

In some embodiments, a maintenance request 152 may identify multiple target servers. Similarly, a maintenance request 152 may specify multiple requested maintenance windows for a particular target server. Logic 116 may be operable to service requests to create any suitable number of maintenance windows for any suitable number of target servers, according to particular needs. If the start or end of a requested maintenance window for a first server overlaps with the start or end of a requested maintenance window for a separate server, logic 116 may be operable to detect this. Logic 116 may be operable to service such requests in parallel, stopping/starting both maintenance windows essentially simultaneously if necessary. Alternatively, logic 116 may service the requests sequentially, and inform user 142 of any resulting delay.

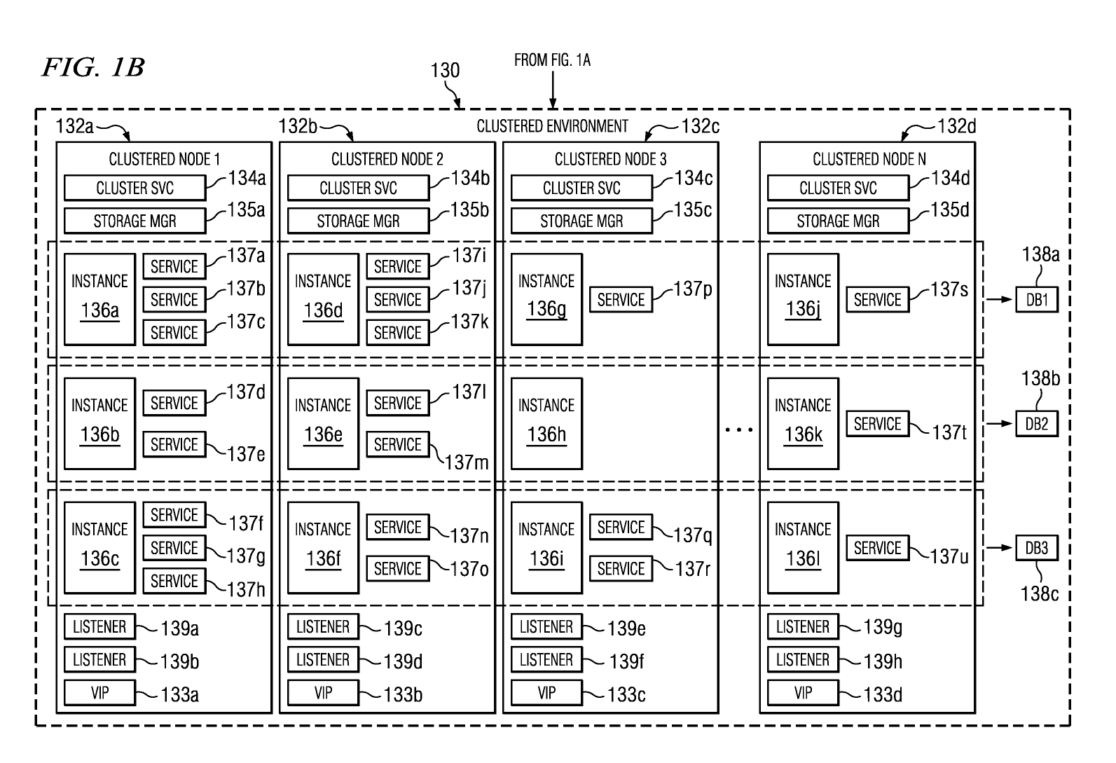

FIG. 2 illustrates an example method 200 for enabling server maintenance using snapshots, according to certain embodiments of the present disclosure. The method begins at step 202. At step 204, management server 110 may receive information identifying a target server, such as a server name, IP address, and/or other suitable information. For example, management server 110 may receive a maintenance request 152 from a user 142 via client 140. The identified target server may be a standalone node 131, clustered node 132, and/or server hosting one or more standalone nodes 131 and/or clustered nodes 132, which needs to undergo maintenance.

At step 206, management server 110 may request and receive credentials. For example, user 142 may input credentials via GUI 144 of client 140. User credentials may represent any username, password, permissions, access code, or other information used to gain access to the target server (e.g. standalone node 131 and/or clustered nodes 132a-d) and/or management server 110. At step 208, management server 110 may verify the credentials provided to ensure that the requestor has the necessary permission to initiate a maintenance window.

If the supplied credentials are successfully verified, the method proceeds to step 210. If not, the method returns to step 206. User 142 may be informed that the credentials were incorrect, and credentials may once again be requested and received.

At step 210, management server 110 may generate a pre-maintenance snapshot 118a of the identified target server. Snapshot 118a may be any collection of information concerning the target server. For example, snapshots 118a-b may identify one or more services, processes, applications, and/or databases running on the target server or any other suitable information. Snapshots 118a-b may also contain state information, parameters, settings, configuration data and/or any other suitable information concerning the target server and/or some or all of those services, processes, application, and/or databases. An example method for capturing snapshots 118a-b of a target server will be described in more detail in connection with FIG. 3. In some embodiments, management server 110 may wait to begin step 210 until the current system time is later than a start time specified in maintenance request 152.

At step 212, management server 110 may stop one or more of the applications, processes, and/or services running on the target server. Management server 110 may be operable to terminate a monitoring process/agent, an enterprise manager, cluster services 134, storage managers 135, instances 136, listeners 139, and/or any other suitable applications, processes, and/or services. In some embodiments, management server 110 may notify user 142 and/or any other appropriate person or system that the requested maintenance window has begun. In some embodiments, it may be desirable to stop or terminate the applications, processes, and/or services in a particular order. An example method for stopping processes and/or services on a target server will be described in more detail in connection with FIG. 4.

At step 214, management server 110 waits for the expiration of the maintenance window before taking further action. In some embodiments, management server 110 may receive a second maintenance request 152, indicating that the maintenance has been completed. In other embodiments, management server 110 may use one or more of a start time, stop time and a duration specified in the maintenance request 152 to determine when the maintenance window has expired. For example, if a stop time was provided, management server 110 may compare the stop time to the current system time. When the system time is later, the method proceeds to step 216. As another example, if a start time and duration were provided, management server 110 may calculate a stop time by adding together the start time and the duration. When the system time is later than the calculated time, the method proceeds to step 216. In some embodiments, if only a start time is provided, management server 110 may use a predetermined duration to calculate a stop time. Management server 110 continues to wait at step 214 until the maintenance window is complete.

At step 216, management server 110 restores the target server to its pre-maintenance state based on the generated pre-maintenance snapshot 118a. Management server 110 may be operable to start and/or configure a monitoring process/agent, an enterprise manager, cluster services 134, storage managers 135, instances 136, services 137, listeners 139, a recovery process, and/or any other suitable applications, processes, and/or services. In some embodiments, it may be desirable to start and/or configure the applications, processes, and/or services in a particular order. In some embodiments, management server 110 may notify user 142 and/or any other appropriate person or system that the requested maintenance window has ended. An example method for starting and/or configuring processes and/or services on a target server will be described in more detail in connection with FIG. 5.

At step 218, may be operable to generate a post-maintenance snapshot 118b of the target server. The information used to create the post-maintenance snapshot 118b may be captured in the same manner as the pre-maintenance snapshot 118a, described above in connection with step 210.

At step 220, management server 110 may compare the pre-maintenance snapshot 118a with the post-maintenance snapshot 118b to identify any discrepancies. If no discrepancies are identified, the target server has been successfully restored to its pre-maintenance state, and the method ends at step 224.

If discrepancies between the two snapshots 118 are identified (and/or cannot be corrected by logic 116), the method proceeds to step 222, where an alert is generated. The alert may be written to a log file, communicated to a system administrator (e.g. via e-mail, text message, etc.), or may take any other suitable format. In some embodiments, alert 158 may be transmitted to user 142 via client 140 and displayed on GUI 144. The alert may include the identified discrepancies, any actions taken to attempt to correct the discrepancies, and/or any other suitable information. The method then ends at step 224.

FIG. 3 illustrates an example method 300 for capturing a snapshot of a server, according to certain embodiments of the present disclosure. The method begins at step 302. At step 304, management server 110 determines whether the target server is a clustered node 132 (e.g. clustered node 132a) or is a server hosting one or more clustered nodes 132. If so, the method proceeds to step 306. If not (e.g. the target server is a standalone node 131), the method proceeds to step 308. At step 306, management server 110 captures cluster service information. Cluster service information may include any suitable information about cluster service 134 running on a clustered node 132, such as configuration information, information about the identities of another clustered nodes 132 within the same clustered environment 130, inter-node routing information, or information about a virtual IP interface 133 of the clustered node 132. The cluster service information and any other suitable information about the running cluster service 134 may be stored in the snapshot.

At step 308, management server 110 determines whether storage manager 135 is running on the target server. If not, the method proceeds to step 312. If so, the method proceeds to step 310. At step 310, management server 110 captures disk group information. Disk group information may be any suitable information regarding the storage devices managed by storage manager 135. Disk group information and any other suitable information about the running storage manager 135 may be stored in the snapshot.

At step 312, management server 110 determines whether any database instances 136 are running on the target server. If at least one instance 136 is running, the method proceeds to step 320. Management server 110 may select an instance 136 to analyze and store identifying information about the selected instance 136 in the snapshot. If no instances 136 are running, the method proceeds to step 314.

At step 320, management server 110 captures state information about the selected instance 136. State information may include whether the instance 136 represents a primary instance of a database or a standby instance of a database. State information may also include whether the instance 136 is operating in a read-only, read-write, or mount mode. The state information and any other suitable information about the selected instance 136 may be stored in the snapshot.

At step 322, management server 110 captures version information for the selected instance 136. Version information may represent a software version associated with the instance 136, its associated services 137, and/or the databases 138 it accesses. The version information for the selected instance 136 may be stored in the snapshot.

At step 324, management server 110 captures services information for the selected instance 136. Services information may include the number and identities of the services 137 associated with the selected instance 136. Services information may also include state information, configuration information, or any other information for each of the services 137 associated with the selected instance 136. State information may include whether a particular service 137 is enabled or disabled. The services information for the selected instance 136 may be stored in the snapshot.

At step 326, management server 110 determines whether the selected instance 136 is a standby database instance 136 (i.e. running in a standby mode). If not, the method proceeds to step 330. If so, the method proceeds to step 328. At step 328, management server 110 captures recovery process information. As discussed above, an instance 136 running in standby mode may have an associated recovery process and a corresponding primary instance 136. Recovery process information may include configuration information regarding the associated recovery process and/or the identity of the corresponding primary instance 136. The recovery process information for the selected instance 136 may be stored in the snapshot.

At step 330, management server 110 determines if additional instances 136 need to be analyzed. If at least one instance 136 is running that has not yet been analyzed, a new instance 136 is selected for analysis, and the method returns to step 320. Identifying information about the new selected instance 136 may be stored in the snapshot. If all running instances 136 have been analyzed, the method proceeds to step 314.

At step 314, management server 110 determines whether any listeners 139 are running on the target server. If not, the method proceeds to step 332. If so, a the method proceeds to step 316. A listener 139 is selected for analysis, and its identity and/or any other suitable information may be stored in the snapshot.

At step 316, management server 110 captures listener information about the selected listener 139. Listener information may include listener address information and/or any other suitable information about the selected listener 139. Listener address information may indicate an address (e.g. IP address, port, etc.) on which listener 139 listens for connections or requests to connect to instances 136 on the target server. The listener information for the selected listener 139 may be stored in the snapshot.

At step 318, management server 110 determines if additional listeners 139 need to be analyzed. If at least one listener 139 is running that has not yet been analyzed, a new listener 139 is selected for analysis, and the method returns to step 316. Identifying information about the new selected listener 139 may be stored in the snapshot. If all running listeners 139 have been analyzed, the method proceeds to step 332.

At step 332, management server 110 determines whether a monitoring process/agent is running on the target server. If so, the method proceeds to step 334. If not, the method proceeds to step 336. At step 334, management server 110 captures monitoring information. Monitoring information may include configuration information and/or any other suitable information about the running monitoring process/agent. The monitoring information may be stored in the snapshot.

At step 336, management server 110 determines whether an enterprise manager is running on the target server. If so, the method proceeds to step 338. If not, the method ends at step 340. At step 338, management server 110 captures enterprise manager information. Enterprise manager information may include configuration information and/or any other suitable information about the running enterprise manager. The enterprise manager information may be stored in the snapshot. At step 340, the method ends.

FIG. 4 illustrates an example method 400 for stopping processes and/or services on a server, according to certain embodiments of the present disclosure. The method begins at step 402. At step 404, management server 110 may stop any monitoring process/agent running on the target server. In some embodiments, it may be desirable to stop a running monitoring process/agent before stopping any other services to avoid having the monitoring process/agent generate alarms or log file entries as the other processes and/or services are stopped. At step 406, management server 110 may stop any enterprise manager running on the target server.

At step 408, management server 110 determines whether the target server is a clustered node 132 or hosts one or more clustered nodes 132. If so, the method proceeds to step 416. If not (e.g. the target server is a standalone node 131), the method proceeds to step 410. At step 416, management server 110 may stop cluster service 134 running on the target server. In some embodiments, stopping cluster service 134 or any other node applications may automatically stop any listeners 139 running on the target server and/or clustered node 132. The method then proceeds to step 412

At step 410, management server 110 determines whether any listeners 139 are running on the target server. If so, the method proceeds to step 418. If not, the method proceeds to step 412. At step 418, management server 110 stops at least one running listener 139 and returns to step 410. Management server 110 may stop any desired running listener 139.

At step 412, management server 110 determines whether any instances 136 are running on the target server. If so, the method proceeds to step 420. If not, the method proceeds to step 414. At step 420, management server 110 stops at least one running instance 136 and returns to step 412. Management server 110 may stop any desired running instance 136. In some embodiments, stopping an instance 136 will automatically stop all services 137 associated with the instance 136.

At step 414, management server 110 stops any storage manager 135 running on the target server. In some embodiments, it may be desirable to stop storage manager 135 after stopping all instances 136. The method then ends at step 422.

FIG. 5 illustrates an example method 500 for starting and/or configuring processes and/or services on a server, according to certain embodiments of the present disclosure. The method begins at step 502. At step 504, management server 110 may determine whether the target server is a clustered node 132 or hosts one or more clustered nodes 132. This determination may be made by retrieving information stored in a pre-maintenance snapshot, for example. If so, the method proceeds to step 506. If not, the method proceeds to step 512.

At step 506, management server 110 checks whether cluster service 134 is already running on the target server. If so, the method proceeds to step 510. If not, the method proceeds to step 508. At step 508, management server 110 starts cluster service 134 (e.g. using cluster service information and/or any other suitable information stored in a pre-maintenance snapshot) on the target server and proceeds to step 510.

At step 510, management server 110 configures cluster service 134 using cluster service information and/or any other suitable information stored in a pre-maintenance snapshot. In certain embodiments, this configuration step may not be performed.

At step 512, management server 110 starts listeners 139 identified in a pre-maintenance snapshot (e.g. using listener information and/or any other suitable information stored in a pre-maintenance snapshot). At step 514, management server 110 configures each listener 139 using listener information and/or any other suitable information stored in a pre-maintenance snapshot. In certain embodiments, this configuration step may not be performed. At step 516, management server 110 starts storage manager 135 if identified in a pre-maintenance snapshot (e.g. using the disk group information and/or any other suitable information stored in a pre-maintenance snapshot). In some embodiments, it may be desirable to start storage manager 135 before starting any instances 136. At step 518, management server 110 configures the storage manager 135 using the disk group information and/or any other suitable information stored in a pre-maintenance snapshot. In certain embodiments, this configuration step may not be performed.

At step 520, management server 110 starts any database instances 136 identified in a pre-maintenance snapshot (e.g. using the state information, version information, services information, and/or any other suitable information stored in a pre-maintenance snapshot). At step 522, management server 110 configures each instance 136 using the state information, version information, services information, and/or any other suitable information stored in a pre-maintenance snapshot. In certain embodiments, this configuration step may not be performed. In certain embodiments, management server 110 may start each service 137 identified in a pre-maintenance snapshot associated with each instance 136 (e.g. using services information and/or any other suitable information stored in a pre-maintenance snapshot.). In some embodiments, management server 110 may additionally configure each service 137 using services information and/or any other suitable information stored in a pre-maintenance snapshot.

At step 524, management server 110 determines whether each instance 136 is a standby database instance 136 (i e running in a standby mode) based on the state information stored in a pre-maintenance snapshot for each instance 136. If not, the method proceeds to step 530. If so, the method proceeds to step 526. At step 526, management server 110 starts an associated recovery process for each standby database instance 136. At step 528, management server 110 configures each recovery process using recovery process information and/or any other suitable information stored in a pre-maintenance snapshot about each standby database instance 136.

At step 530, management server 110 starts an enterprise manager if identified in a pre-maintenance snapshot (e.g. using the enterprise manager information and/or any other suitable information stored in a pre-maintenance snapshot), and configures the enterprise manager using the enterprise manager information and/or any other suitable information stored in a pre-maintenance snapshot. In certain embodiments, configuration of the enterprise manager may not be performed. At step 532, management server 110 starts a monitoring process/agent if identified in a pre-maintenance snapshot (e.g. using the monitoring information and/or any other suitable information stored in a pre-maintenance snapshot), and configures the monitoring process/agent using the monitoring information and/or any other suitable information stored in a pre-maintenance snapshot. In certain embodiments, configuration of the monitoring process/agent may not be performed. In some embodiments, it may be desirable to start the monitoring process/agent last to avoid having the monitoring process/agent generate alerts or log file entries regarding processes and/or services that have not yet been started or restored. The method then ends at step 534

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

Although the present disclosure has been described in several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a target server operable to:
access one or more databases; and
run one or more processes supporting access to the one or more databases; and
a management server comprising one or more processors, the management server operable to:
receive a maintenance request, wherein the maintenance request comprises a maintenance window;
generate a server state snapshot by capturing the identities and configurations of the one or more processes running on the target server;
stop the one or more processes; and
restore, after the expiration of the maintenance window, the one or more processes based on the server state snapshot.

2. The system of claim 1, wherein:
the server state snapshot is a first server state snapshot; and
the management server is further operable to generate, after restoring the one or more processes, a second server state snapshot.

3. The system of claim 2, wherein the management server is further operable to compare the first server state snapshot and the second server state snapshot to identify any discrepancies.

4. The system of claim 3, wherein the management server is further operable to generate an alert comprising the identified discrepancies.

5. The system of claim 1, wherein:
the target server comprises a clustered node; and
the management server is further operable to generate the server state snapshot by capturing at least cluster service information.

6. The system of claim 1, wherein the management server is further operable to generate the server state snapshot by capturing one or more of:
storage manager information;
database instance information;
listener information; and
monitoring information.

7. The system of claim 1, wherein the management server is further operable to restore the one or more processes based on the server state snapshot by:
starting a first process of the one or more processes; and
configuring the first process using information in the server state snapshot associated with the first process.

8. A method, comprising:
receiving a maintenance request, wherein the maintenance request comprises an identity of a target server;
generating, by one or more processors, a server state snapshot by capturing information about one or more processes running on the target server;
stopping, by the one or more processors, the one or more processes; and
restoring, by the one or more processors, the one or more processes based on the server state snapshot.

9. The method of claim 8, wherein the server state snapshot is a first server state snapshot, and further comprising generating, after restoring the one or more processes, a second server state snapshot.

10. The method of claim 9, further comprising comparing, by the one or more processors, the first server state snapshot and the second server state snapshot to identify any discrepancies.

11. The method of claim 10, further comprising generating, by the one or more processors, an alert comprising the identified discrepancies.

12. The method of claim 8, wherein:
the target server comprises a clustered node; and
generating the server state snapshot comprises capturing at least cluster service information.

13. The method of claim 8, wherein generating the server state snapshot comprises capturing one or more of:
storage manager information;
database instance information;
listener information; and
monitoring information.

14. The method of claim 8, wherein restoring the one or more processes based on the server state snapshot comprises:
starting a first process of the one or more processes; and
configuring the first process using information in the server state snapshot associated with the first process.

15. One or more non-transitory computer-readable storage media embodying logic that is operable when executed to:
receive a maintenance request, wherein the maintenance request comprises an identity of a target server;
generate a server state snapshot by capturing information about one or more processes running on the target server;
stop the one or more processes; and
restore the one or more processes based on the server state snapshot.

16. The one or more non-transitory computer-readable storage media of claim 15, wherein:
the server state snapshot is a first server state snapshot; and
the logic is further operable when executed to generate, after restoring the one or more processes, a second server state snapshot.

17. The one or more non-transitory computer-readable storage media of claim 16, wherein the logic is further operable when executed to compare the first server state snapshot and the second server state snapshot to identify any discrepancies.

18. The one or more non-transitory computer-readable storage media of claim 17, wherein the logic is further operable when executed to generate an alert comprising the identified discrepancies.

19. The one or more non-transitory computer-readable storage media of claim 15, wherein:
the target server comprises a clustered node; and
the logic is further operable when executed to generate the server state snapshot by capturing at least cluster service information.

20. The one or more non-transitory computer-readable storage media of claim 15, wherein the logic is further operable when executed to restore the one or more processes based on the server state snapshot by:
starting a first process of the one or more processes; and
configuring the first process using information in the server state snapshot associated with the first process.
